(19) United States
(12) Patent Application Publication
(10) Pub. No.: US 2025/0075045 A1
(43) Pub. Date: Mar. 6, 2025

(54) Fibroin molded body and mixture for molding

(71) Applicant: CANON VIRGINIA, INC., Newport News, VA (US)

(72) Inventor: Yu Kameno, Kanagawa (JP)

(21) Appl. No.: 18/818,068

(22) Filed: Aug. 28, 2024

Related U.S. Application Data
(60) Provisional application No. 63/579,884, filed on Aug. 31, 2023.

(51) Int. Cl. C08J 5/18; C08K 7/06; C08K 7/14; D01B 7/06; D01C 3/02

(52) U.S. Cl. CPC C08J 5/18; C08K 7/06; C08K 7/14; D01B 7/06; D01C 3/02; C08J 2389/00; D10B 2211/22

(57) ABSTRACT

Disclosed are a molded body and method for manufacture of same, with the molded body including fibroin having high impact strength and flexural properties, the molded body being capable of maintaining impact strength and flexural properties over a long period of time, with the molded body including 80 parts or more by weight of fibroin, with the fibroin including fibrous fibroin and non-fibrous fibroin.

### CROSS-REFERENCE TO RELATED APPLICATIONS

The present application claims priority to U.S. Provisional Patent Application No. 63/579,884, which was filed with the U.S. Patent and Trademark Office on Aug. 31, 2023, the entire disclosure of which is incorporated herein by reference.

### BACKGROUND

### 1. Field

The present disclosure relates to a molded body formed of fibrous fibroin and non-fibrous fibroin.

### 2. Description of the Related Art

These days, efforts are being made to process fibroin, which is a protein with high biocompatibility, into products. Fibroin is one of the main proteins that composes the silkworm cocoon. For example, JP7096549B2 discusses a method for mixing raw silk into a molded body to improve strength, when obtaining a molded body from a powder derived from silk.

However, since raw silk contains a significant among of highly water-soluble sericin, conventional methods encounter difficulties maintaining the strength of a molded body over a long period, particularly when the method discussed in JP7096549B2 is utilized.

### SUMMARY

The present disclosure overcomes shortcomings of conventional systems by providing a molded body which can maintain a high strength over a prolonged period of time that includes 80 parts by weight or more of fibroin, wherein the fibroin consists of fibrous fibroin and non-fibrous fibroin, allowing the molded body to maintain its strength over a long period of time.

Accordingly, an aspect of the present disclosure provides a molded body that includes at least 80 parts by weight of fibroin, with the fibroin including fibrous fibroin and non-fibrous fibroin.

Another aspect of the present disclosure provides a mixture for molding that includes fibrous fibroin and powder-form fibroin, with a solid component of the mixture contains 80 parts by weight of fibroin or more.

A further aspect of the present disclosure provides a method for manufacturing a molding body, with the method including obtaining a mixture comprising fibrous fibroin and powder-form fibroin, with a solid component of the mixture containing 80 parts by weight of fibroin or more, and compressing the mixture so that the fibrous fibroin is bound with the powder-from fibroin.

These and other embodiments, objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

The accompanying drawings, which are incorporated herein and form part of the specification, illustrate various embodiments, objects, features, and advantages of the present disclosure.

FIGS. 1A and 1B provide a table summarizing the various embodiments of the present disclosure; and

FIG. 2 is a perspective view of a molded body according to the present disclosure.

### DETAILED DESCRIPTION OF EXEMPLARY EMBODIMENTS

The present disclosure has several embodiments and relies on patents, patent applications and other references for details known to those of the art. Therefore, when a patent, patent application, or other reference is cited or repeated herein, it should be understood that the patents, patent applications and nonpatent literature is incorporated by reference in its entirety for all purposes as well as for the proposition that is recited.

### <Mixture for Molding>

The present disclosure provides a mixture for molding that includes 80 parts by weight or more of fibroin in a solid component. The fibroin contained in the mixture includes fibrous fibroin and powdered fibroin. Preferably, the powdered fibroin is amorphous. Embodiments that were produced utilizing this mixture for molding will be described below.

The mixture for molding includes a solid component that is a substantially solid component from which solvents such as water were excluded. For example, the component may be substantially solid when a rate of weight loss is 0.1% per day or less when heated to 80 degrees Celsius under atmospheric pressure. For example, in conventional molding methods, solvents such as water may be used in a mixture for molding. However, the solid component of the present description is a substantially solid component from which solvents were excluded. Various methods can be considered to confirm the total amount of a solid component that does not contain solvents. For example, when heated to 80 degrees Celsius under atmospheric pressure, the total component amount of a solid component whose weight loss rate may be confirmed as 0.1% per day or less.

The fibroin contained in the solid component of the mixture for molding of the present disclosure is a component contained in silkworm cocoons, spider silk, or hornet silk produced by wasp larvae, and 70 parts by weight or more is bio-based polymeric material composed of the amino acids; glycine and alanine. Fibroin is considered superior from the viewpoints of biocompatibility and biodegradability. In the case of natural silkworm cocoons (raw silk), typically, 25 to 30 parts by weight is sericin and 75 to 80 parts by weight is fibroin. On the other hand, the mixture for molding in the present disclosure contains 80 parts by weight or more of fibroin. Therefore, for example, a fibroin, of which the sericin content in the raw silk was reduced by a degumming process, is used.

When silkworm cocoons are used as raw material, using only degummed cocoons, from which sericin is removed and ensuring that the amount of fibroin becomes 80 parts by weight or more, as a mixture for molding is allowed, and it is also allowed to prepare a mixture for molding by mixing raw silk containing sericin with degummed cocoons so that the amount of fibroin becomes 80 parts by weight or more. In addition, the purity of fibroin may be heightened by a method such as sericin dialysis using the difference in water solubility between fibroin and sericin. Furthermore, silkworm cocoons of which the concentration of fibroin in the raw silk is artificially heightened by using silkworms or wasps, on whom DNA modification was performed, may be used.

As mentioned above, sericin is highly water-soluble and can be dissolved in water after molding. For this reason, the sericin content of the mixture for molding of the present disclosure is preferably 10 parts by weight or less, and more preferably may be 3 parts by weight or less. In order to simplify the degumming process, 0.1 parts by weight or more of sericin may be included. For example, when using a general degumming process, approximately 2 parts by weight of sericin remain.

The weight of sericin contained in the mixture for molding can be verified with a method that analyzes the completely dissolved mixture using liquid chromatography-mass spectrometry (LC-MS)/MS, as described in Int. J. Mol. Sci. 2023, 24 (1), 259, or with an infrared absorption spectrum, or the like.

When using silkworm cocoons, the sericin content in the silkworm cocoons may be confirmed by comparing the weight before and after degumming. Degummed cocoons usually contain 2 parts by weight of sericin and 98 parts by weight of fibroin, and the weight of sericin in the silkworm cocoons can be determined by adding the weight of the sericin that was reduced in the degumming process.

Further, the mixture for molding of the present disclosure may contain less than 20 parts by weight of components other than fibroin. However, from the viewpoint of durability of the molded body after molding, it is preferable that for the components other than fibroin, have low solubility in water. In addition, if the molded body will be used as a medical material, it is preferable that components other than fibroin are highly biocompatible. For example, it is possible to use silicones or hydrogels as other components, such as those used in contact lenses, carbon fiber cloth with confirmed biocompatibility, glass fiber cloth, a combination thereof, or the like, with the molded body including at least one component selected from a group including carbon fiber and glass fiber.

### 1-A. Fibrous Fibroin

The fibrous fibroin of the present disclosure is a filamentous fibroin, or a processed body, in which the fibroin forms a crystal body via hydrogen bonds in a radial direction and is elongated in a direction perpendicular to the radial direction.

The average thickness (diameter) of the fibrous fibroin is 1 micrometer or more and 200 micrometers or less. If less than 1 micrometer, the strength of the molded body that has gone through the molding process can be insufficient. In addition, if greater than 200 micrometers, miscibility with powder can deteriorate.

From the viewpoint of the mechanical strength of the molded body, fibrous fibroin of a length of 0.2 millimeters or more is included and, in an embodiment, it is preferable that fibrous fibroin of a length of 1.0 millimeter or more is included. In the case of silkworms, since the length of a cocoon that can be obtained from a single individual exceeds 1 kilometer, it is preferable that the cocoons are cut appropriately for ease of mixing with powdered fibroin. It is preferable that the fibrous fibroin after cutting includes fibroin of a length of 50 millimeters or less and, in an embodiment, it is preferable that it includes fibroin of a length of 30 millimeters or less.

The average thickness and the average length of the fibrous fibroin may be calculated from the area and the outer circumference by capturing an image of 100 fibers or more with a camera or a scanner, or the like, and analyzing the image. Specifically, based on the thickness X and the fiber length Y, the area is obtained by multiplication of X and Y, with a circumference that is twice the sum of X and Y. After determining X and Y of each fibrous fibroin, an average value of each X thickness is obtained of the fibrous fibroin, and an average value of each fiber length Y is obtained of the fibrous fibroin.

It is preferable that the proportion of fibrous fibroin is 10 parts by weight or more in the mixture. If less than this, the strength of the molded body that can be obtained after molding may decrease. Preferably, the proportion of the fibrous fibroin with respect to the fibroin is 50 parts by weight or more. On the other hand, when there is too much fibrous fibroin, it becomes difficult for the fibrous fibroin to bond to each other in the molding process, because there is less powdered fibroin, as described herein. As a result, the strength of the molded body is reduced. Thus, it is preferable that the proportion of fibrous fibroin with respect to the fibroin is 85 parts per weight or less in the mixture.

Filamentous fibroin includes, for example, cocoons, degummed cocoons, and spun fibroin, or the like. The processed product can include a cut filamentous fibroin product, a mesh-like product processed like a woven fabric or a silk screen, or a cut product thereof. That is, the fibrous fibroin of the present disclosure may be a one-dimensional long filament, a two-dimensional sheet, i.e., sheet form, processed like a woven fabric, or cut versions of these.

The molecular weight of fibrous fibroin is preferably 130 kDa or more. If less than 130 kDa, the fiber becomes brittle and the mechanical strength of the molded body may decrease. Generally, the molecular weight in silkworm cocoons is said to be 300 kDa or more, and the molecular weight decreases by boiling. Therefore, the molecular weight of fibroin can be controlled by the boiling time. In the present disclosure, the molecular weight of fibrous fibroin is limited to 300 kDa or less, when used after cleaning to remove dust or the like that may be attached to the cocoon. The molecular weight may be confirmed by using fibroin after desalination of dissolved fibroin in an aqueous solution such as Lithium Bromide (LiBr).

For the fibrous fibroin of the present disclosure, using fibroin with a crystallization ratio of 50% or more is preferable. Normally, the crystallization ratio of silkworm cocoons is 50% or more, unless dissolved at the molecular level. For the crystallization ratio in the present disclosure, refer to the method described in Nature Materials 19, 102-108 (2020) (hereinafter referred to as Non-Patent Document 2), and use the method described below.

### <Method for Measuring Crystallization Ratio>

Measurement is made of the infrared absorption spectrum of the surface of the molded body every 1 cm⁻¹ in the range from 1580 cm⁻¹ to 1720 cm⁻¹. The linear function passing through the value at 1580 cm⁻¹ and the value at 1720 cm⁻¹ of the resulting spectrum is calculated, made as a baseline, and subtracted from a measured value. The resulting spectrum is considered to be the sum of four spectra derived from random coil, β-sheet I, β-sheet II, and β-turn, and is referred to as the effective spectrum.

Spectra derived from random coils can be approximated as summations of Gaussian functions having variable peak centers between 1645 cm⁻¹ and 1655 cm⁻¹, and spectra derived from β-sheets I, β-sheets II, and β-turns can be approximated as summations of Gaussian functions having fixed peak centers of 1620, 1698, and 1685 cm⁻¹ respectively. In the four Gaussian functions, for the peak intensity and the deviation of the Gaussian functions, the sum as variables is determined to obtain a synthesized spectrum having nine variables.

In the range 1580 cm⁻¹ to 1720 cm⁻¹, the absolute value of the difference between the effective spectrum and the synthesized spectrum is determined at every 1 cm⁻¹, the sum is calculated, and made as the spectral error. The spectral error is set with respect to the integrated value of the effective spectrum as the error rate, and fit of the nine variables of the synthesized spectrum is made to reduce the error rate. When the error rate after fitting has become 3% or less, the error rate is the converged one, and the four spectra constituting the synthesized spectrum are considered to be the actual spectra of each component. The sum of the three spectral integrated values derived from β-sheet I, β-sheet II, and β-turn is then calculated with respect to the integrated value of the effective spectrum in the range from 1580 cm⁻¹ to 1720 cm⁻¹ as the crystallization ratio of the present disclosure. Since the crystallization ratio (Sum of β-sheet I, β-sheet II, and β-turn) in the case of silk fibroin is less than 20% in the dry state before heat molding and 50% or more after heat molding according to Non-Patent Document 2, if the crystallization ratio in the present disclosure exceeds 50%, the molded body is determined to have a desirable strength. However, the index of the crystallization rate may be different depending on the strength required for the molded body.

Fitting can be performed using the software supplied with the infrared absorption spectrum measuring device, graph analysis software, solver add-in in Microsoft Excel software, or the like.

### 1-B. Powdered Fibroin

In the present disclosure, powdered fibroin is used as non-fibrous fibroin. Powdered fibroin is fibroin that has been turned into powder. For the diameter of powdered fibroin, a diameter of 200 micrometers or less is preferable. If greater than 200 micrometers, the powdered fibroin is not preferable because it becomes difficult to mix with fibrous fibroin. The diameter can be confirmed by a device that measures the size of the powder.

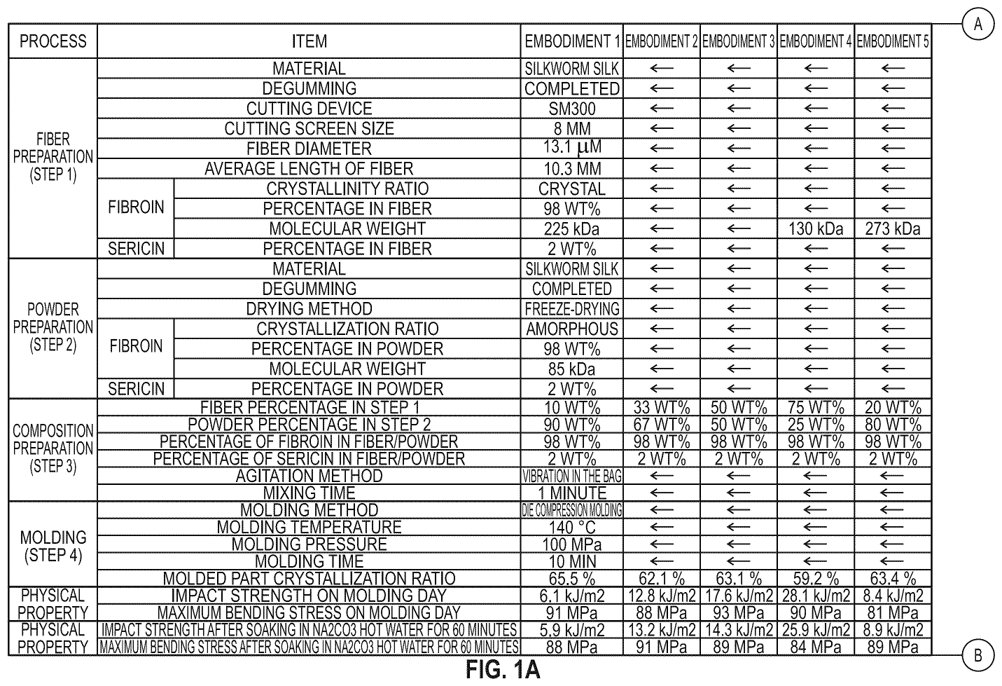

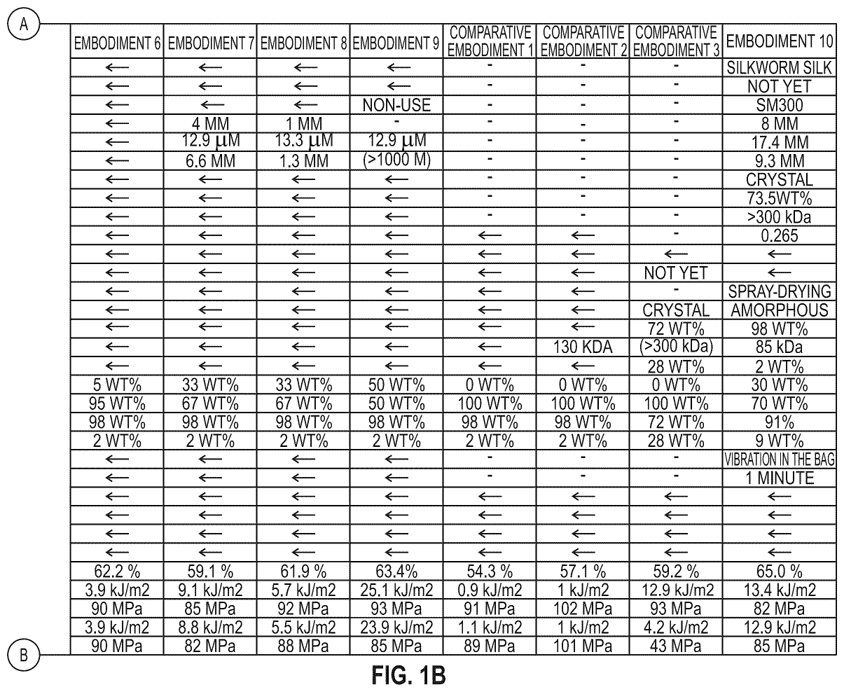

Powdered fibroin is amorphous. Fibroin is, as described above, in a crystalline state, and has poor reactivity, while amorphous fibroin melts during molding. For that reason, when heat molding a mixture of amorphous powdered fibroin and fibrous fibroin, the process of melting bonds the amorphous powdered fibroin to the fibrous fibroin, thereby improving the strength of the molded body. Alternatively, low pressure curing during the molding process provides similar strength. See, the physical properties summarized in FIGS. 1A and 1B, which provide table summarizing the various embodiments of the present disclosure.

Amorphous fibroin can be obtained by a method as described in Non-Patent Document 2. That is, it can be manufactured by using a process of dissolving degummed fibroin in an aqueous solution, and then removing water from the aqueous solution. Because de watering by heating can accelerate crystallization and impair meltability during molding, methods such as lyophilizing enabling dewatering while cooling, and spray-drying, which requires very little time to heat the aqueous solution, can be used.

When using the lyophilizing method, the freezing temperature has no particular limit as long as the aqueous solution freezes, but since the freezing point of an aqueous solution in which a solute is dissolved is lower than the freezing point of water, it is preferable that it is −10° C. or lower, and more preferably −20° C. or lower. When drying under reduced pressure after freezing, the temperature is preferably −20° C. or higher, and more preferably −15° C. or higher, because the lower the drying temperature, the longer it takes to dewater. In a sufficiently frozen sample, the pressure is preferably 600 Pa or less, which is the pressure at the triple point of water. but if the frozen sample is partially liquefied due to temperature unevenness of the sample, the aqueous solution foams, so 100 Pa or less is preferable, and 50 Pa or less is more preferable. For the dried material after moisture removal, it is preferable to release the vacuum after the temperature has reached 10° C. or higher. Lower than this may cause condensation to occur inside the sample and the dried material may adsorb water, resulting in gelation, or the like, of the dry fibroin material.

When using spray-drying, the fibroin concentration in the aqueous solution may be adjusted in advance to facilitate spraying. It is preferable to shorten the exposure time of the fibroin to heat as much as possible by adjusting the air pressure and flow rate of the spray. If the fibroin is heated and crystallizes due to the equipment being heated during spraying, it is also possible to spray while cooling the periphery of the equipment and the sample collection area with a cooling device, or the like.

In order to make the powder, the powder may be ground after freeze-drying using a jet mill, a hammer mill, a ball mill, a pin mill, or the like, or the powder may be obtained by spray-drying.

In the present disclosure, amorphous means that the crystallization rate of the fibroin is 20% or less. Calculation of the crystallization ratio with the same method described in section 1-A.

### 1-C. Mixing Fibrous Fibroin and Powdered Fibroin

Fibrous fibroin and non-fibrous (powdered or powder-form) fibroin are mixed and agitated inside a chamber. From the viewpoint of biocompatibility, the amount of impurities (for example, sericin) contained in the fibrous fibroin and the powdered fibroin is preferably 20 parts by weight or less, and more preferably 10 parts by weight or less. Normally, since cocoons that have been degummed to increase the fibroin purity contain about 2 parts by weight of sericin, they can contain 2 parts by weight or more of impurities (sericin).

It is preferable that the mixing and agitating is performed with a method that does not easily generate heat. In the present disclosure, for example, cyclone using air flow, propeller agitation, vibration agitation, or the like, can be used.

Due to this process, it is possible to obtain a mixture in which amorphous non-fibrous (powdered/powder-form) fibroin is attached around crystalline fibrous fibroin.

### Molding Method

The molding temperature of the mixture for molding of the present disclosure is preferably performed at 80° C. or higher to melt the powdered fibroin and let the fibrous fibroin bond to each other. In addition, because fibroin thermally decomposes at 200° C. or higher, it is preferable that the molding temperature is 180° C. or lower.

The molding pressure is preferably 300 MPa or less, and more preferably 100 MPa or less. When using a pressure of 300 MPa, capital investment cost can be high. In addition, in order to melt powdered fibroin and let it bind to fibrous fibroin, it is preferable to mold it at a pressure of 30 MPa or more.

It is preferable to select the molding time appropriately so the crystallization ratio becomes 50% or more, after the powdered fibroin has crystallized due to the molding process.

Various molding method may be used, including injection molding, extrusion molding, compression molding, and the like, without limitation.

### Molded Body

The molded body of the present disclosure contains 80 parts by weight or more of fibroin. At this time, the fibroin includes fibrous fibroin and non-fibrous fibroin. The fibrous fibroin is bonded by the non-fibrous fibroin.

In the molded body of the present disclosure, a component other than fibroin may be included, but it is preferable that any component other than fibroin have high biocompatibility and low solubility in water. If the component other than fibroin is sericin, it is preferable that the sericin is 10 parts by weight or less, in order to reduce the deterioration to the maximum limit that occurs during long-term use, as described herein. Preferably, the amount of sericin is 3 parts by weight or less. In addition, since it is difficult to use fibroin from which sericin is completely removed, sericin can be 0.1 parts by weight or more. The amount of sericin in the molded body can be confirmed with LC-MS/MS or the infrared absorption spectrum, or the like, as described herein.

Since fibrous fibroin is a crystalline body and is not melted by the molding process, it exists in the molded body in a fibrous state. For that reason, the preferable conditions for the length and thickness of the fibrous fibroin are the same as those described herein for the mixture for molding.

It is preferable that the proportion of fibrous fibroin in the fibroin is 10 parts by weight or more in the mixture. If less than this, the strength of the molded body obtained after molding may be insufficient. Preferably, the proportion of fibrous fibroin in the fibroin is 50 parts by weight or more. If there is too much fibrous fibroin, it becomes difficult for the fibrous fibroin to bond with each other in the molding process, because there is less non-fibrous fibroin. Since this can reduce the strength of the molded body, it is preferable that the proportion of fibrous fibroin to fibroin is 85 parts by weight or less in the mixture. A non-fibrous fibroin is a tightly integrated fibroin that is distinct from a fibrous fibroin in a molded body. It is equivalent to an amorphous powdered fibroin, prepared with a mixture for molding, that is molded and integrated. Because the powdered fibroin clings around the fibrous fibroin in the mixture for molding, the non-fibrous fibroin clings around the fibrous fibroin in the molded body, and the fibrous fibroin is bound by the non-fibrous fibroin.

In order for the molded body to have high strength, it is important that the fibroin is crystallized as a whole molded body. At the time of being a mixture before molding, the fibrous fibroin is crystallized, while the powdered fibroin is amorphous. Therefore, in terms of strength, it is important that powdered fibroin melted in the process of molding is crystallized. Since the non-fibrous fibroin clings around the fibrous fibroin, the crystallization rate of the non-fibrous fibroin can be confirmed by measuring the crystallization rate of the surface of the molded body.

It is preferable that the crystallization ratio of the surface of the molded body is 50% or more, indicating a state in which non-fibrous fibroin is crystallized. If less than this, the molded body may not have sufficiently high strength. For the crystallization ratio calculation method, the same method as the method described in the section on mixture for molding can be used as described herein.

Verification of mixing of fibrous fibroin in a molded body may be observed in optical microscopic images of the cross-section of a bent, molded body. For example, a vertical orientation, i.e., standing up, of the entangled fibrous fibroin is observed, without limitation to a particular orientation. That is, a molded body that was broken after being used in an impact strength test or flexural modulus stress test may be magnified and observed.

The amount of fibrous fibroin in a fibroin mixture may be quantified on a proportional basis at the mixture stage but may also be determined by analysis of the molded body itself. For example, non-fibrous fibroin is high density and yellowish in color, while fibrous fibroin is low density and white in color. Thus, non-fibrous fibroin versus fibrous fibroin can be distinguished from the proportion of yellow and white areas in the cross-section of the molded body. In addition, the proportion of fibrous fibroin can also be calculated from fluorescence dyeing property or gas adsorption property using the low-density characteristic of fibrous fibroin.

In the molded body of the present disclosure, fibrous fibroin and non-fibrous fibroin are bonded together. That is, the gaps between fibrous fibroin are filled with dense non-fibrous fibroin, and the fibrous fibroin and the non-fibrous fibroin are substantially integrated without any gaps. Since the cross-sectional view of the fibrous fibroin in the molded part is a substantially circular in shape, i.e. elliptical shaped, it is possible to confirm whether or not the ellipses are integrated without any gaps between the ellipses by observing them by scanning electron microscope.

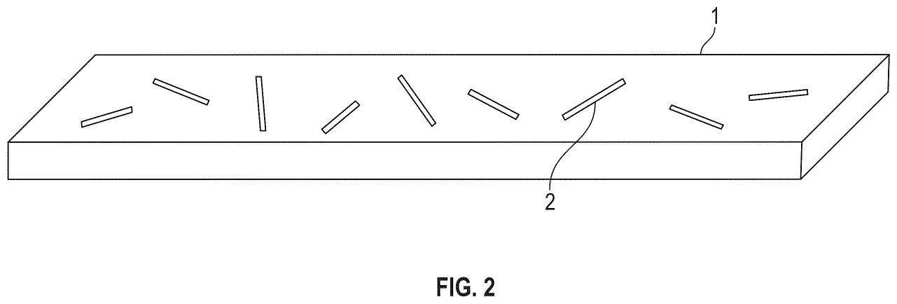

FIG. 2 is a perspective view of a molded body according to the present disclosure. As illustrated in FIG. 2, a molded body 1 is provided with Fibrous fibroin embedded therein.

Confirmation of the mechanical properties of a molded body was performed using Charpy impact strength tests in accordance with ISO179-1 and a flexural properties test in accordance with ISO178. It is preferable that the impact strength is 5 KJ/m² or more and that the maximum bending stress is 50 MPa or more, and more preferably, the impact strength is 12 kJ/m² or more and the maximum bending stress is 70 MPa or more. That is a maximum bending stress of the molded body after being dipped in 0.02 M aqueous sodium carbonate solution at 60 degrees Celsius for 60 minutes is 50 MPa or more. In addition, the impact strength is 50 kJ/m² or less and the maximum bending stress is 200 MPa or less.

In case a molded body is not large enough to measure by impact strength and bending test, a larger sized sample is utilized for strength testing, based on uniformity of strength throughout the sample.

The impact strength of 100 parts by weight may be estimated by manufacturing molded bodies using other materials to which 0, 25, 50, or 75 parts by weight of the fibroin mixture of this disclosure are added and performing strength measurements with the other materials.

For the impact strength and flexural properties described above, it is preferable that it is maintained even after 60 minutes immersion in a 0.02M sodium carbonate aqueous solution heated to 60° C. Although proteins are generally considered to be weak in alkalinity, they can be said to be strong enough to withstand long-term use if their strength is maintained under the above conditions.

<Methods for preparing Fibrous Molded Body>

### Embodiment 1

### Step 1. Preparation of Fibrous Fibroin

After washing silkworm cocoons with water, a 0.02 mol/L sodium carbonate aqueous solution was heated to 95° C., and degumming was performed for 15 minutes to turn them into degummed fibroin.

To measure the molecular weight, the degummed fibroin were put into a 9.3 mol/L LiBr aqueous solution and dissolved by performing agitation for 4 hours at 60° C. Cellulose tubes 30/32 (fractionated molecular weight of 12000˜14000) manufactured by Sekisui Chemical Co., Ltd. were used for desalination. In addition, after dilution with pure water, the aqueous solution was confirmed to be homogeneous without precipitation by visual inspection A molecular weight measurement was performed using SDS-PAGE. For the details of the measurement method, the disclosure of L. S. Wray et al., J Biomed Mater Res B Appl Biomater. 2011 October; 99 (1): 89-101 was followed. As a result of measuring, the molecular weight was determined to be 225 kDa.

The degummed fibroin before dissolution were finely ground into fibrous fibroin using a shearing mill (Model number SM300, manufactured by Verder Scientific) set with a screen having 8 mm square holes. When using a scanning electron microscope (Model No. JSM-F100, manufactured by JEOL Ltd.) to verify the fiber diameter, it was determined to be 13.1 μm. In addition, when the average length of 100 fibers was calculated by scattering them on a scanner whose resolution was set to 10 μm, it was determined to be 10.3 mm. In addition, when the infrared absorption spectrum of the fibers was measured with the ATR method, using the FT-IR/NIR spectrometer Frontier (manufactured by PerkinElmer), and the crystallization ratio was measured, it was determined to be 64.9%, which confirmed that the fibers were crystalline.

### Step 2. Preparation of Fibroin Powder

After washing silkworm cocoons with water, they were boiled in a 0.02 mol/L sodium carbonate aqueous solution for 30 minutes to perform degumming. The degummed fibroin were put into a 9.3 mol/L LiBr aqueous solution and dissolved by performing 4 hours of agitation at 60° C. Cellulose tubes 30/32 (fractionated molecular weight of 12000˜14000) manufactured by Sekisui Chemical Co., Ltd. were used for desalination. In addition, after dilution with pure water, the aqueous solution was confirmed to be homogeneous without precipitation by visual confirmation. This aqueous solution was used as the aqueous fibroin solution. As a result of measuring the molecular weight of this aqueous solution, it was determined to be 85 kDa.

After the aqueous fibroin solution was spread on a tray so the thickness became 5 mm, the tray was placed on a shelf in a freeze dryer (Model No. FD-550P, manufactured by Tokyo Electric Machine) and cooled to −30° C. After 3 hours, and after freezing was confirmed visually, decompression was started at −6° C. and 30 Pa, and dewatering was started. After 24 hours, decompression was released after letting the sample temperature rise to 15° C., and the sheet-shaped dried body was taken out.

Then, the sample was pulverized by grinding for 30 seconds in a mill apparatus (Crash Milser IFM-C 20G, manufactured by Iwatani Industries).

When the infrared absorption spectrum of the powder was measured with the ATR method using the FT-IR/NIR spectrometer Frontier, the crystallization ratio was determined to be 10%, thus confirming the sample as being an amorphous body to be used as powdered fibroin.

### Step 3. Preparation of the Mixture for Molding

10 parts by weight of fibrous fibroin obtained in Step 1 and 90 parts by weight of the powdered fibroin obtained in Step 2 were mixed in a bag and agitated by a strong vibration type table top vibrator manufactured by Azwan, vibrating for approximately 1 minute to obtain the mixture for molding.

### Step 4. Molding Process

4.8 g of the mixture for molding was filled into a bottom mold in which a hole of 10 mm in length, 85 mm in width, and 50 mm in depth was machined. After a top mold was installed, it was moved to a 20t hand press machine and compressed to achieve a molding pressure of 35 MPa at room temperature. After releasing the load, the mold was taken out temporarily. After the hand press machine was heated to 140° C., the mold was moved to the hand press machine again, and the mold was heated and compressed to achieve a molding pressure of 100 MPa. After 10 minutes, the load was released and air cooled. When the temperature cooled to 40° C., the mold was disassembled and the molded body was taken out. When measuring the crystallization ratio of the surface of the molded body, it was determined to be 65.5%. This process was performed four times, and four molded bodies were produced for physical property evaluation.

### Step 5: Mechanical Properties Evaluation Process

A notching machine (Model No. 189-PN, manufactured by Yasuda Seiki Co., Ltd.) was used on the first molded body, and notching was conducted to a depth of 2 mm in the molded body. After that, the molded body was set in a Charpy impact testing machine (Model No. 258-D, manufactured by Yasuda Seiki Co., Ltd.,) and an impact test determined an impact strength of 6.1 kJ/m². When the fracture surface of this sample was observed with a scanning electron microscope, it was confirmed that non-fibrous fibroin was densely packed in between the fibrous fibroin.

The second molded body was also measured at a pressing speed of 2 mm/min using a universal material testing machine (Model 5582, manufactured by Instron Japan Co., Ltd.). The maximum bending stress was 91 MPa.

### Step 6. Mechanical Properties Degradation Evaluation Process

After the third and fourth molded body manufactured in Step 4 were immersed in a 0.02M sodium carbonate aqueous solution that was heated to 60° C. for 60 minutes, the mechanical properties were evaluated with the same method as in Step 5. The evaluation results are shown in FIG. 1A.

### Embodiment 2

In Embodiment 2, fibroin was mixed in Step 3 so the fibrous fibroin obtained in Step 1 became 33 parts per weight and the powdered fibroin obtained in Step 2 became 67 parts by weight, and then agitated by vibration. Steps 4, 5, and 6 were performed in the same manner as in Embodiment 1. The crystallization ratio and mechanical properties of the obtained molded body are shown in FIG. 1A.

### Embodiment 3

In Embodiment 3, fibroin was mixed in Step 3 so the fibrous fibroin obtained in Step 1 became 50 parts per weight and the powdered fibroin obtained in Step 2 became 50 parts per weight, and then agitated by vibration. Steps 4, 5, and 6 were performed in the same manner as in Embodiment 1. The crystallization ratio and mechanical properties of the obtained molded body are shown in FIG. 1A.

### Embodiment 4

In Step 1 of Embodiment 4, the same procedure was performed except that the molecular weight of the degummed fibroin was set to 130 kDa by lengthening the boiling time of the silkworm cocoons. Step 2 was performed in the same manner as in Embodiment 1. In Step 3, fibroin was mixed so the fibrous fibroin obtained in Step 1 became 75 parts per weight and the powdered fibroin obtained in Step 2 became 25 parts per weight, and then agitated by vibration. Steps 4, 5, and 6 were performed in the same manner as in Embodiment 1. The crystallization ratio and mechanical properties of the obtained molded body are shown in FIG. 1A.

### Embodiment 5

In Step 1 of Embodiment 5, the same procedure was performed except that the molecular weight of the degummed fibroin was set to 273 kDa by shortening the boiling time of the silkworm cocoons. Step 2 was performed in the same manner as in Embodiment 1. In Step 3, fibroin was mixed so the fibrous fibroin obtained in Step 1 became 20 parts per weight and the powdered fibroin obtained in Step 2 became 80 parts per weight, and then agitated by vibration. Steps 4, 5, and 6 were performed in the same manner as in Embodiment 1. The crystallization ratio and mechanical properties of the obtained molded body are shown in FIG. 1A.

### Embodiment 6

After Steps 1 and 2 of Embodiment 5, in Step 3 of Embodiment 6, fibroin was mixed so the fibrous fibroin obtained in Step 1 became 5 parts by weight and the powdered fibroin obtained in Step 2 became 95 parts by weight, and then agitated by vibration. Steps 4, 5, and 6 were performed in the same manner as in Embodiment 1. The crystallization ratio and mechanical properties of the obtained molded body are shown in FIG. 1B.

### Embodiment 7

In Step 1 of Embodiment 6, the degummed fibroin were pulverized using a shearing mill (Model number SM300, manufactured by Verder Scientific) set with a screen having 4 mm square holes. When measuring the diameter and average length of the fibers, using the measurement method described in Embodiment 1, they were determined to be 12.9 μm and 6.6 mm, respectively. In addition, when the infrared absorption spectrum of the fibers was measured and the crystallization ratio was measured, it was determined to be 59.1%, and it was confirmed that the fiber was a crystalline body.

Step 2 and subsequent steps were performed in the same manner as Embodiment 6. The crystallization ratio and mechanical properties of the obtained molded body are shown in FIG. 1B.

### Embodiment 8

In Step 1 of Embodiment 6, the degummed fibroin were pulverized using a shearing mill (Model number SM300, manufactured by Verder Scientific) that was set with a screen having a 1 mm ladder holes. When measuring the diameter and average length of the fibers, using the measurement method described in Embodiment 1, they were determined to be 13.3 μm and 1.3 mm, respectively. In addition, when the infrared absorption spectrum of the fibers was measured, it was determined to be 61.9%, and when the crystallization rate was measured, it was confirmed that the fiber was a crystalline body. Step 2 and subsequent steps were performed in the same manner as Embodiment 6. The crystallization ratio and mechanical properties of the obtained molded body are shown in FIG. 1B.

### Embodiment 9

In Step 1 of Embodiment 3, the degummed fibroin were made into fibrous fibroin without cutting. When measuring the diameter of the fibers using the measurement method described in Embodiment 1, they were determined to be 12.9 μm each. When the infrared absorption spectrum of the fibers was measured, it was determined to be 63.4%, and when the crystallization rate was measured, it was confirmed to be a crystalline body. Step 2 and subsequent steps were performed in the same manner as Embodiment 3. The crystallization ratio and mechanical properties of the obtained molded body are shown in FIG. 1B.

### Comparative Embodiment 1

Without performing Step 1 of Embodiment 1, Step 2 was performed in the same manner. In Step 3, only powdered fibroin was used and made into a mixture for molding. Steps 4, 5, and 6 were performed in the same manner as in Embodiment 1. The crystallization ratio and mechanical properties of the obtained molded body are shown in FIG. 1B.

### Comparative Embodiment 2

Without performing Step 1 of Embodiment 1, in Step 2, the boiling time of the silkworm cocoons was shortened, and after preparing a 100 kDa aqueous fibroin solution, freeze-drying and grinding were performed in the same manner, and it was made into powdered fibroin. Step 3 and subsequent steps were performed in the same manner as in Comparative Embodiment 1. The crystallization ratio and mechanical properties of the obtained molded body are shown in FIG. 1B.

### Comparative Embodiment 3

Without performing Step 1 of Embodiment 1, in Step 2, after the silkworm cocoons were washed in water and dried, they were pulverized using a shearing mill (Model number SM300, manufactured by Verder Scientific), that was set with a 0.25 mm ladder hole screen, without performing degumming. When measuring the amount of sericin and the crystallization ratio, they were determined to be 28 parts by weight and 59%, respectively, and this was used as powdered fibroin. After that, in Step 3, only powdered fibroin was used as the mixture for molding. Steps 4, 5, and 6 were performed in the same manner as in Embodiment 1. The crystallization ratio and mechanical properties of the obtained molded body are shown in FIG. 1B.

### Embodiment 10

In Step 1 of Embodiment 1, the silkworm cocoons were washed with water and not degummed. When measuring the amount of sericin, it was determined to be 26.5%. This was finely ground using a shearing mill (Model number SM300, manufactured by Verder Scientific) that was set with a screen having 8 mm square holes, and made into fibrous fibroin. When measuring the crystallization ratio, it was determined to be 65.0%.

Subsequently, after preparing a 3 weight % aqueous fibroin solution in Step 2 of Embodiment 1, spray-drying was performed. The crystallization ratio of the obtained powder was measured and determined to be 12%.

In Step 3, the fibroin was put in a bag so the fibrous fibroin obtained in Step 1 became 30 parts by weight and the powdered fibroin obtained in Step 2 became 70 parts by weight and 1 minute of vibration agitation was performed, to make it into a mixture for molding. The sericin content of this mixture for molding was calculated to be 8 parts by weight. Steps 4, 5, and 6 were performed in the same manner as in Example 1. The crystallization ratio and mechanical properties of the obtained molded body are shown in FIG. 1B.

The practice of the present disclosure may employ, unless otherwise indicated, conventional techniques and descriptions of organic chemistry, polymer technology, molecular biology (including recombinant techniques), cell biology, biochemistry, and immunology, which are within the skill of the art.

In referring to the description, specific details are set forth in order to provide a thorough understanding of the examples disclosed. In other instances, well-known methods, procedures, components and circuits have not been described in detail as not to unnecessarily lengthen the present disclosure.

It should be understood that if an element or part is referred herein as being “on”, “against”, “connected to”, or “coupled to” another element or part, then it can be directly on, against, connected or coupled to the other element or part, or intervening elements or parts may be present. In contrast, if an element is referred to as being “directly on”, “directly connected to”, or “directly coupled to” another element or part, then there are no intervening elements or parts present. When used, term “and/or”, includes any and all combinations of one or more of the associated listed items, if so provided.

Spatially relative terms, such as “under” “beneath”, “below”, “lower”, “above”, “upper”, “proximal”, “distal”, and the like, may be used herein for ease of description to describe one element or feature's relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below. The device may be otherwise oriented (rotated 90 degrees or at other orientations) and the spatially relative descriptors used herein are to be interpreted accordingly. Similarly, the relative spatial terms “proximal” and “distal” may also be interchangeable, where applicable.

The term “about,” as used herein means, for example, within 10%, within 5%, or less. In some embodiments, the term “about” may mean within measurement error.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

The terminology used herein is for the purpose of describing particular embodiments only and is not intended to be limiting. The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “includes”, “including,” and “containing” are to be construed as open-ended terms (i.e., meaning “including, but not limited to,”) unless otherwise noted. Specifically, these terms, when used in the present specification, specify the presence of stated features, integers, steps, operations, elements, and/or components, but do not preclude the presence or addition of one or more other features, integers, steps, operations, elements, components, and/or groups thereof not explicitly stated. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

It will be appreciated that the methods and compositions of the instant disclosure can be incorporated in the form of a variety of embodiments, only a few of which are disclosed herein. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A molded body comprising:
at least 80 parts by weight of fibroin,
wherein the fibroin comprises fibrous fibroin and non-fibrous fibroin.

2. The molded body according to claim 1, wherein the non-fibrous fibroin is mixed with the fibrous fibroin for molding the molded body.

3. The molded body according to claim 1, wherein the fibrous fibroin clings with the non-fibrous fibroin during the mixing.

4. The molded body according to claim 1, wherein an average diameter of the fibrous fibroin is 1 μm or more and 200 μm or less.

5. The molded body according to claim 1, wherein the fibrous fibroin includes fibrous fibroin with a length of 0.1 mm or more and 50 mm or less.

6. The molded body according to claim 1, wherein the molded body comprises at least 10 parts by weight of the fibrous fibroin.

7. The molded body according to claim 1, wherein a molecular weight of the fibrous fibroin is 130 kDa or more.

8. The molded body according to claim 1, further comprising sericin,
wherein a content of the sericin in the molded body is 0.1 parts by weight or more and 10 parts by weight or less.

9. The molded body according to claim 1, wherein the fibrous fibroin includes fibrous fibroin in sheet form.

10. The molded body according to claim 1, further comprising at least one component selected from a group including carbon fiber and glass fiber.

11. The molded body according to claim 1, wherein a crystallization ratio of the fibroin is 50% or more.

12. The molded body according to claim 1, wherein an impact strength of the molded body is 5 KJ/m² or more and a maximum bending stress of the molded body is 50 MP or more.

13. The molded body according to claim 1, wherein a maximum bending stress of the molded body after dipping in 0.02 M aqueous sodium carbonate solution at 60 degrees Celsius for 60 minutes is 50 MPa or more.

14. A mixture for molding comprising:
fibrous fibroin; and
powder-form fibroin,
wherein a solid component of the mixture contains 80 parts by weight of fibroin or more.

15. The mixture of claim 14, wherein a crystallization ratio of the powder-form fibroin is 20% or less.

16. A method for manufacturing a molding body, the method comprising:
obtaining a mixture comprising fibrous fibroin and powder-form fibroin, wherein a solid component of the mixture contains 80 parts by weight of fibroin or more, and
compressing the mixture so that the fibrous fibroin is bound with the powder-from fibroin.

17. The method of claim 16, wherein the fibrous fibroin and the powder-form fibroin are produced from silk cocoons.

18. The method of claim 16, wherein the powder-form fibroin is produced by:
degumming silk cocoons to obtain silk fibroin,
dissolving the silk fibroin in an aqueous solution, and
obtaining the powder-form fibroin by dewatering the aqueous solution with the degummed silk cocoons.

19. The method of claim 18, wherein the dewatering is performed by at least one of lyophilization and spray drying.

20. The method of claim 15, wherein a temperature is 80 degrees Celsius or more and 180 degrees Celsius or less,
wherein the compression is performed at a pressure of 30 MPa or more and 300 MPa or less, and
wherein the compression heats the mixture.
